(19) United States
(12) Patent Application Publication
(10) Pub. No.: US 2009/0037802 A1
(43) Pub. Date: Feb. 5, 2009

(54) Integrated System and Method to Create a Video Application for Distribution in the Internet

(76) Inventors: Matthias Klier, Leipzig (DE); Steve Riedel, Leipzig (DE); Peggy Barbara Hack-Fleming, San Diego, CA (US)

Correspondence Address: WHITE-WELKER & WELKER, LLC, P.O. BOX 199, CLEAR SPRING, MD, 21722-0199, US

(21) Appl. No.: 11/831,227

(22) Filed: Jul. 31, 2007

(51) Int. Cl. G06F 3/01

(52) U.S. Cl. 715/202

(57) ABSTRACT

A system and method for individuals to create and manage an online video presentation for promoting skills, products, or ideas using a computer and a web cam, or any other video recording equipment. The video can be integrated into a portfolio of related documents, files, and folders, such as an online job application consisting of resume, cover letter, transcripts, and certificates. The software allows for the user to create a video script consisting of different video parts or topics that are being recorded, replayed, edited, deleted, and previewed later. The user may also select between different styles of layouts or masters including design, font, size, or color etc. Sample texts, sample videos, and portfolios as well as tips and recommendations for creating an ideal presentation are being provided in the menu. The portfolio will be uploaded to the server and provided to the viewer through and Internet link.

### CROSS REFERENCE TO RELATED APPLICATIONS

This application claims priority from U.S. Provisional Patent Application Ser. No. 60/834,316, entitled “Integrated System and Method to Create a Video Application for Distribution in the Internet”, filed on 31 Jul. 2006.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a video resume. More specifically the present invention relates to a system and method to create a video application for distribution via the Internet.

### BACKGROUND OF THE INVENTION

Traditionally, a job seeker's application consists of resume, cover letter, and attachments such as transcripts and recommendation letters. Applications are being sent to recruiters either via mail or via e-mail, or a web link is provided to the recruiter that leads to the user's resume. Online job web sites allow job seekers to create a virtual resume which is being stored in electronic format.

For certain recruiting scenarios, it is of great advantage to the recruiter if skill and talents are being presented personally. Traditionally, that has been done through personal interviews, demonstrations, or auditioning which is a time consuming and costly process. In addition, with growing globalization of the job market, and future employees located far away, companies are trying to acquire the best knowledge possible about the user's future employees. In addition, foreign potential employees or interns must often present proof of employment before applying for a work visa in the user's home country. This leads to the situation that many companies have not had the chance to personally interview an employee.

In order to overcome these disadvantages it would be of benefit to both the employer and the job seeker to have access to a system and method which allows for the creation of a digital video presentation. The present invention provides such a system and method.

### SUMMARY OF THE INVENTION

The present invention relates to a system and method for individuals to create and manage an online video presentation for promoting skills, products, or ideas.

It is one aspect of the present invention that the video presentation can be integrated into a portfolio of related documents, files, and folders, such as an online job application consisting of resume, cover letter, or transcripts. The portfolio is digitally stored on the computer of the job web site of the user's computer. The system and method is available to the user through download or stored on CD ROM.

It is another aspect of the invention that the user has access to sample and master applications including but not limited to resumes and cover letters in various different languages, and sample texts for video presentations, which are stored on the provider's server and can be accessed by the user while creating the presentation.

In another aspect, the user has the option to create a script for his or her later recordings. The script may consist of separate video parts which an be recorded, replayed, deleted, edited, and previewed separately. In addition, titles can be given to each video part, such as ‘Education’, ‘Professional Experience’, or ‘Skills’. The recruiter can later choose between viewing the whole video or only selected video parts.

It is another objective of the present invention to provide a system that allows the user to record, delete, and edit the video parts until a satisfactory result has been achieved.

Still another objective of the present invention is to provide the user with the option to select between different styles, formats and layouts such as design, font, size, or color for both the video presentation as well as the related digital documents such as resume and cover letter.

Still another objective of the present invention is to provide the user with the option to create more than one video presentation consisting of different video parts. As a result, a new video can consist of several existing video parts from other videos and new video parts. This is useful if certain video parts relate closely to the specific view such as a specific company.

Still another objective of the present invention is to provide the user with the option to store and compress the presentation including the video and related digital documents on the provider's server or to have it transferred on his or her own FTP server where it can be accessed by the viewer through an Internet link.

These and other objects of the present invention will become readily apparent upon review of the figures and detailed description.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1a is a simplified view of the user workflow for a software download embodiment of the present invention;

FIG. 1b is a diagrammatic view of the user workflow for a software download embodiment of the present invention;

FIG. 2a shows the user workflow in combination with software functions and support processes of an embodiment enabled via a web browser;

FIG. 2b is a diagrammatic view of the user workflow for a software download embodiment enabled via a web browser;

FIG. 3a illustrates the recruiting process for web enabled software from creation of the application by a job seeker to viewing of the application by a recruiter;

FIG. 3b illustrates the recruiting process for the downloadable software from creation of the application by a job seeker to viewing of the application by a recruiter;

FIG. 4 is a detailed flow chart illustrating the process of creating the script, recording, and re-recording of the video parts and changing or deleting video parts for both an embodiment enabled via web browser or downloadable software embodiment of the present invention;

FIG. 5 is a flow chart of the preparation of the video script including texts and titles for both an embodiment enabled via a web browser and downloadable software;

FIG. 6 is a flow chart of the video recording process for both an embodiment enabled via a web browser and downloadable software;

FIG. 7 demonstrates the interaction between user software and digital data stored on the server;

FIG. 8 is a wire frame screen shot illustrating the “create script screen” of the present invention;

FIG. 9 is a wire frame screen shot illustrating the selectable templates of the present invention;

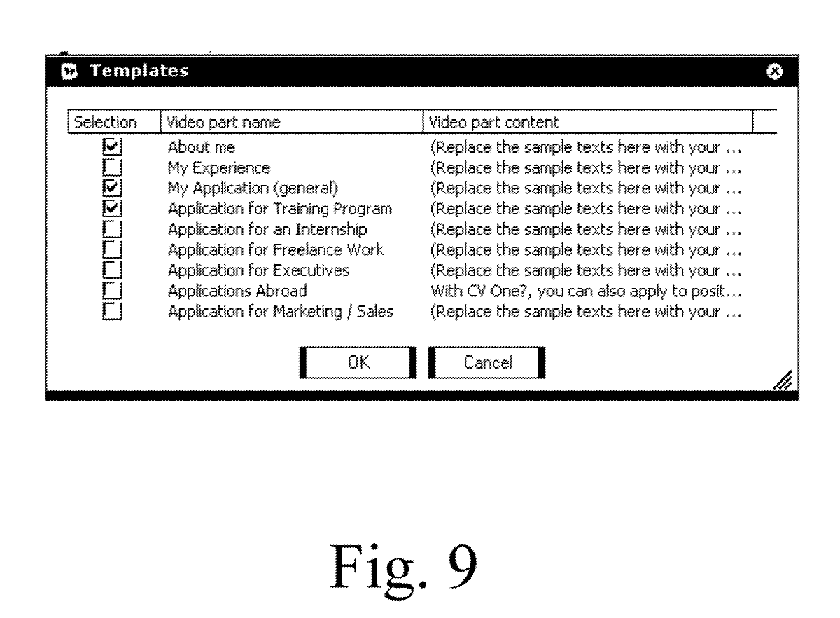

FIG. 10 is a wire frame screen shot illustrating the create script screen of the present invention; and

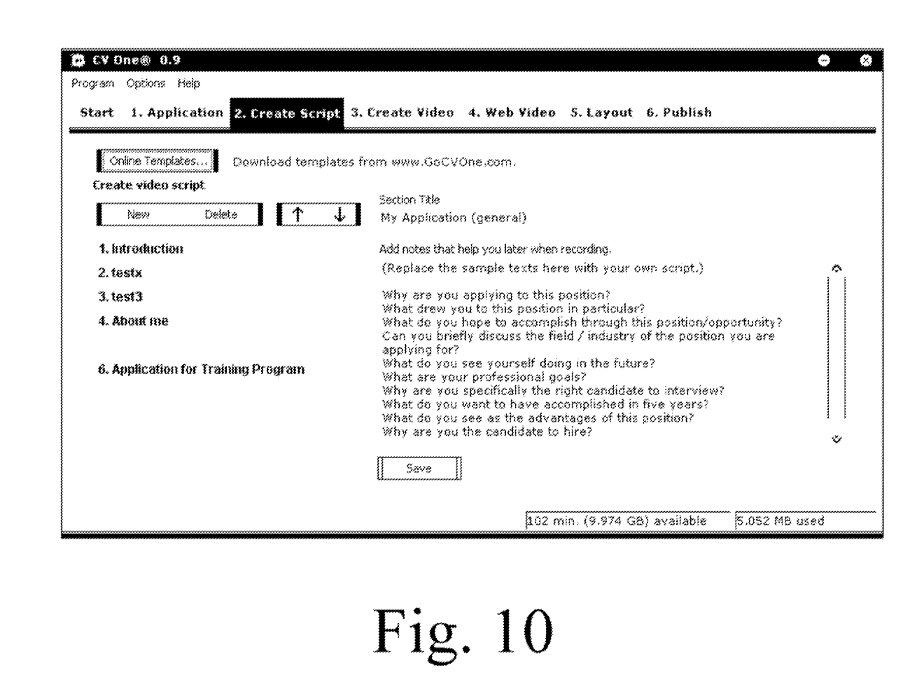

FIG. 11 is a flow chart illustrating the process for script creation from a question catalog.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

The present invention is an integrated system and method to create a video presentation for promoting skills, products, or ideas using a computer and a web cam, or any other video recording equipment in addition to the inventor's software. The present invention enables the conversion of the traditional job application process into not only an online application process but into an online video application process. The software of the present invention enables the ability to upload and present all three parts of the application on one page—(1) video, (2) resume (open) and (3) cover letter and other attachments (as links). The users have the choice to select different layouts for the user's online video resume.

The details/core functions of the present invention are: Resume file upload; Video script including creation of video parts with headlines/questions, descriptions/text; Countdown to recording; Replay; Re-Record; Preview functions; Layout selection (to customize the application); Publishing and creation of URL link; and Sending out the URL link to employers, recruiters, career centers, friends, etc.

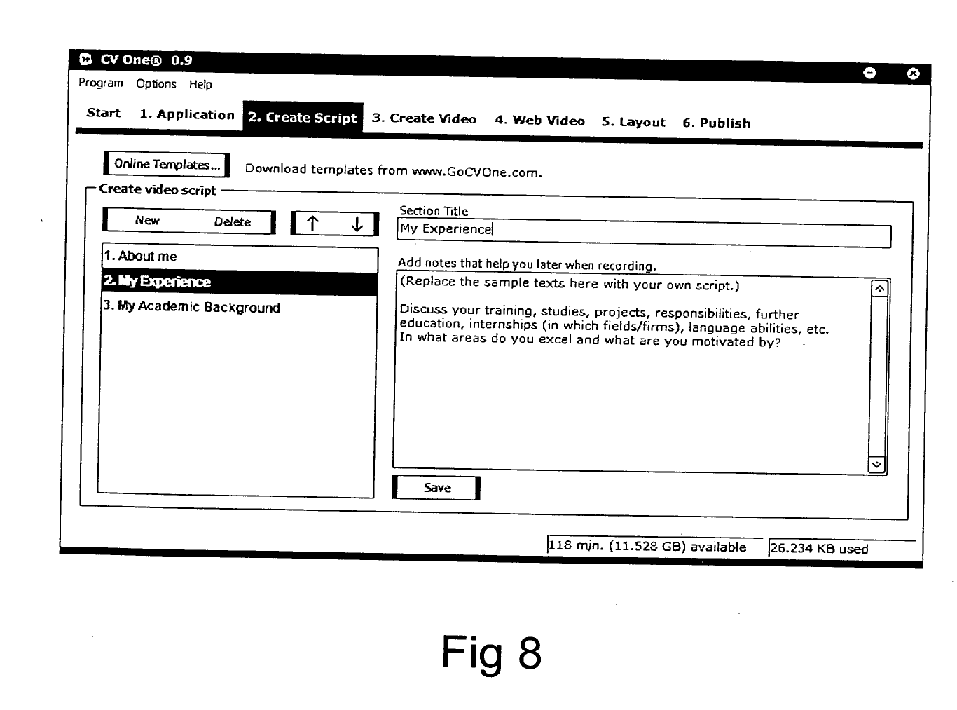

The present invention allows a user to split the video presentation in to different parts or sections and record them separately as shown in FIG. 8. The sections can be named and assigned by the user, such as “Introduction”, “Academic Background”, “Practical Experience”. The advantage is that recruiters, when later viewing the video application, can easily jump back and forth between the sections they are interested in viewing.

When preparing for the video recording, the users can take down notes that will later appear when recording the video. Online templates for the video script provide a help feature for users to create the user's video script. By clicking on “Online Templates” users can download and select various scripts, texts, questions, and suggestions for section titles.

The following list of additional features are considered to be patentable elements that distinguish it from current devices used and known in the prior art.

A. A teleprompter can be displayed when recording the video. The speed of the teleprompter can be adjusted by the user.

B. Instead of downloading the system software and create in the video application on user's own PC or laptop and upload it to the system's web server in the end, users can choose to work directly on a web server to create the user's video application with a flash version of the system software.

C. Users can upload the user's files (resume, cover letter, credentials, etc.) in different formats such as Word, HTML, or PDF. PDF is the most practicable format for the viewer (recruiter). Therefore, the system has implemented an automatic PDF converter for the users who upload files other than PDF format. That saves the user time and hassle.

D. When the user starts the software program from his PC or laptop, the system has integrated an automatic check for program updates.

E. The system of the present invention provides for the posting of the user's job application page on the system's web server versus the user's own space. This function allows the user to choose between having the resume hosted on the system's web server or transfer it to his/her own server. So, if a user decided that he only wants to use the system's software to create the video resume but wants full control over his video resume page (such as unlimited views, unlimited access/hosting etc.) he can choose the system's FTP. This is also interesting for companies that ask the user's job users to create a video resume with the system and refer to the system's web site. But if they want full control over the video resumes that are being created, they can transfer it to the user's server.

Users who don't have a web cam, can still use the Flash version by just recording voice (audio). A static picture will be shown in the video window.

After the user has installed software and web cam on his or her personal computer, he or she has access to her previously set up profile on the provider's server. In case of a new user, he or she will need to sign up as a user. Then, the user can create one or more applications including a resume, cover letter, and upload attachments in different formats such as Word, PDF, or RTF.

The candidate can then set up a video script. The video script can consist of one or more video parts. Titles can be given to each part such as ‘Education’, ‘Professional Experience’, or ‘Skills’. The user has access to sample and master applications including but not limited to resumes and cover letters in various different languages, and sample texts for video presentations, which are stored and updated on the provider's server and can be accessed by the user while creating the script or presentation.

The script can be edited until a satisfactory result has been achieved.

The user can then start recording of the video parts. Recording starts through mouse click followed by a countdown 3, 2, 1. The video parts can be replayed, deleted, and recorded again until a satisfactory result has been achieved.

The video will then be transformed and compressed into a different format such as Flash or Microsoft WMV. The transformation/compression process will be visible to the user as a progress report.

The user can then select one of the layouts and designs of his or her video and all the other related digital documents such as design, color, font style, or font size. The digital layouts are stored on the server and provided to the user.

A preview function gives the user one more chance to view the entire portfolio.

With the system and method of the present invention the users then have the option to store the user's video presentation on the provider's server or upload it to the user's own web space via FTP.

If the user chooses to host the presentation on the provider's server, a URL link will automatically be provided, and the link will be implemented in the virtual application which is being sent to recruiters later. If the user chooses to host the application using his or her own web space, a link to start the index file must be created manually by the user. The two hosting options allow the user to choose between having his/her resume hosted on our server or transfer it to his/her own server. If a user decided that he only wants to use the system of the present invention to create the video resume but wants full control over his video resume page, such as unlimited views, unlimited access/hosting etc., he can choose the system's FTP. This is also interesting for recruiters that ask the user's job users to create a video resume with the system of the present invention and refer to our site. But if they want full control over the video resumes that are being created, they can transfer it to the user's server.

The user can check for software updates by selecting the appropriate menus, or will be notified while starting or running the program.

Individuals and companies can use the present invention to present the user's skills, qualifications, and talents, products, and services instead of or in addition to a physical or virtual portfolio. The invention an be used by artists, inventors, or entrepreneurs to present the user's work, portfolios, business plans, or ideas.

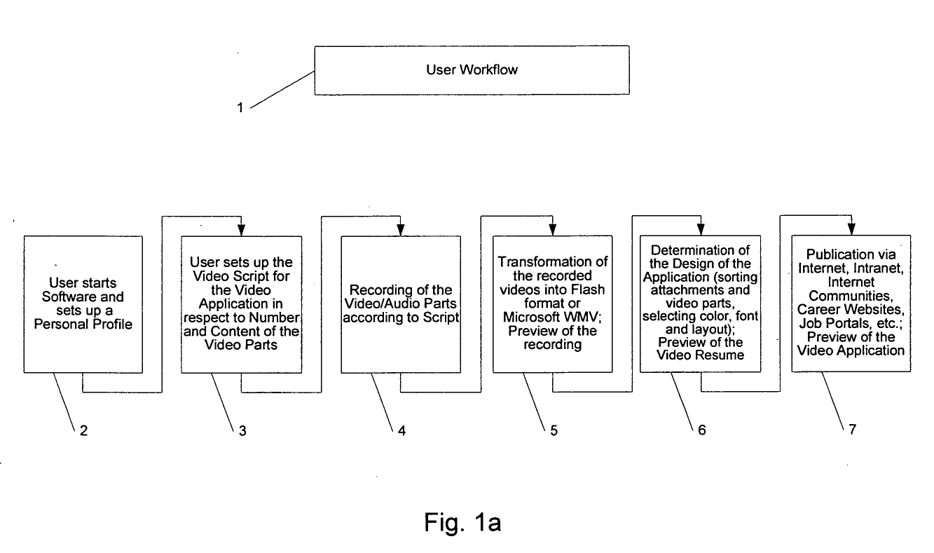

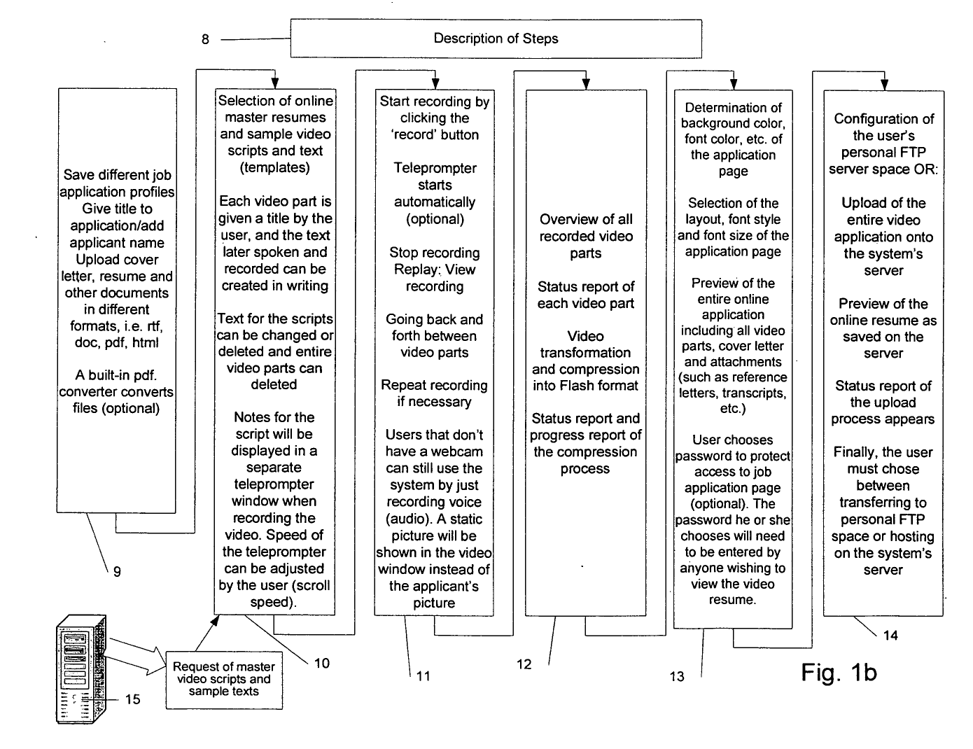

Now referring to FIG. 1a the user workflow 1 in a software download embodiment only, the user first starts the system software and sets up a personal profile 2. Next, the user sets up the video script for the video application in respect to number and content of video parts 3. The recording of the video/audio parts according to the script then occurs 4 and the recoding is transformed into the desired electronic format 5 such as flash, Microsoft WMV and the recording can be previewed. A determination of the design of the application along with sorting attachments and video parts, selecting color, font and layout 6 is completed and then can be previewed. Finally, publication via the Internet 7 occurs.

Referring now to FIG. 1b, the steps 8 of the process to create a recording are illustrated in a flow chart. In a first step 9 the user saves different job application profiles and gives titles to the applications. Additionally, the user uploads a cover letter, resume, and other documents. The documents can be uploaded in any format and a built in PDF converter is provided to convert the files if desired by the user.

In a second step 10, the user can select from online master resumes and sample video scripts and text templates from a server 15. Each video part is given a title by the user, and the text is later spoken and recorded or created in writing. Text for the scripts can be changed or deleted an entire video parts can be deleted. Notes for the script will be displayed in a separate teleprompter window when recording the video. Speed of the teleprompter can be adjusted by the user.

In a third step 11, the user starts recording by selecting the record button and the teleprompter starts automatically if desired. When the recording is completed, the user can replay the recording to review it going back and forth between parts and repeat recording if necessary. User that don't have a web cam can still use the system by just recording voice or audio while a static picture is displayed in the video window instead of the user's picture.

In a fourth step 12, and overview and status report of all video parts is completed and the video is transformed and compressed into the desired electronic format, and a status report of the compressing is shown.

In a fifth step 13, the user determines the background color, font, color, etc of the application page and a selection of the layout, font style, and font size of the application is also made. Next a preview of the entire online application including all video parts, cover letter, and attachments such as reference letters, transcripts, etc are included. A user then chooses a password to protect access to job application page and the password created by the user will be required by anyone to view the video resume.

In a sixth and final step 14, the user configures his personal FTP server space or uploads the entire video application onto the system's server 15. Once uploaded a preview of the application as saved on the server can be viewed as well as a status report on the upload process.

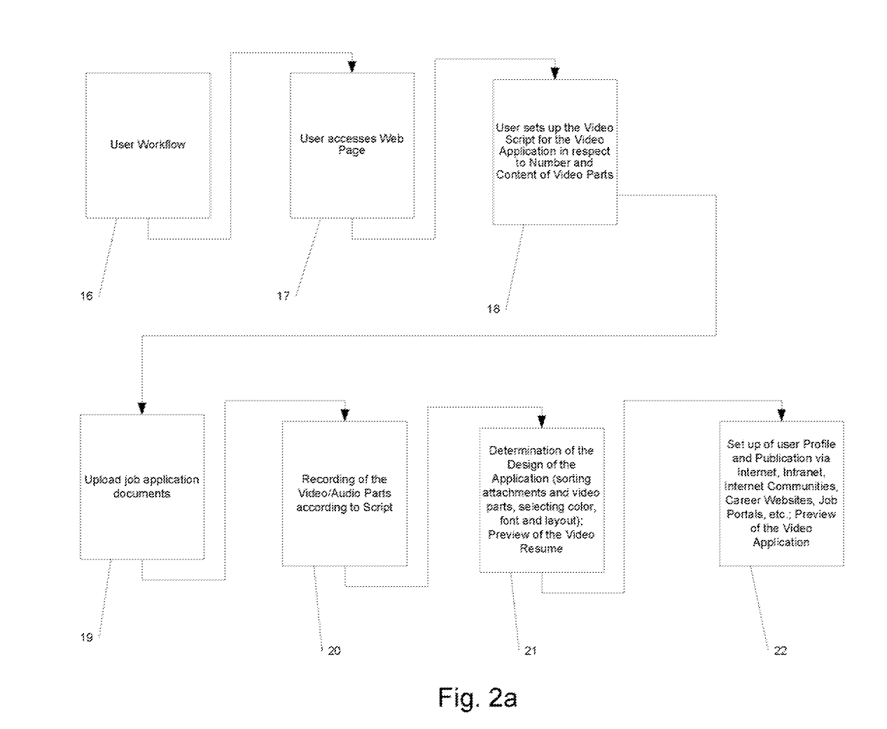

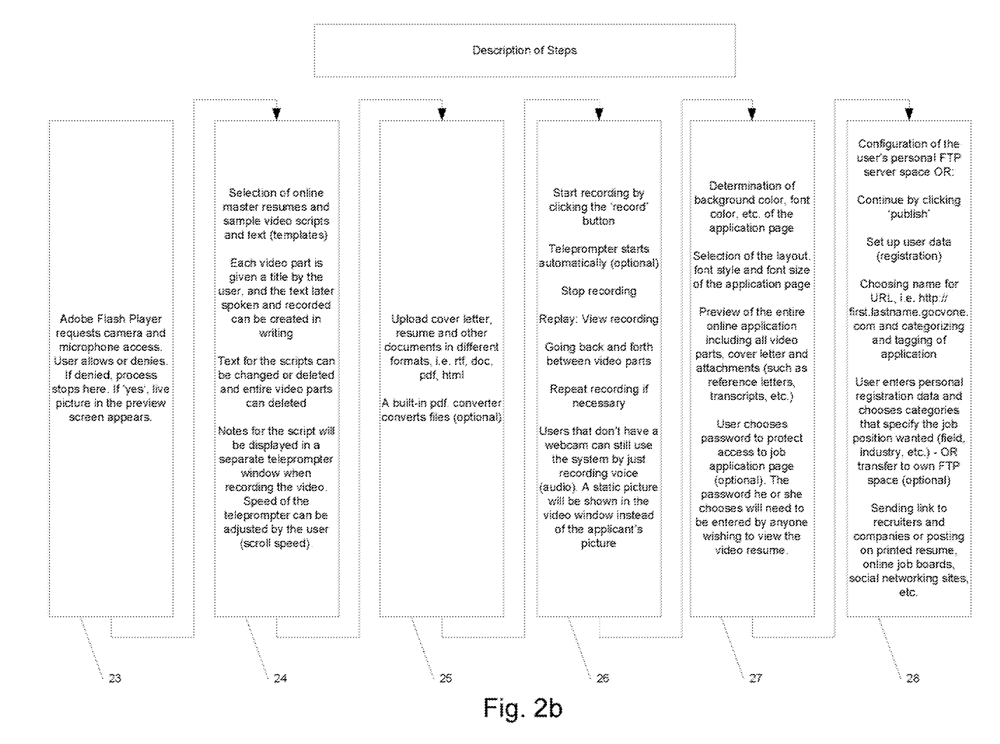

Now referring to FIG. 2a, the user workflow 16 in a web version embodiment only, the user first accesses a web page 17 and then set up the video script for the video application in respect to number and content of video parts 18. Job application documents are then uploaded 19. Next the recording of the video/audio parts according to the script occurs 20 A determination of the design of the application along with sorting attachments and video parts, selecting color, font and layout 21 is completed and the can be previewed. Finally the user profile and publication via the Internet 22 occurs.

Referring now to FIG. 2b, the steps of the process to create a recording in a web version only embodiment are illustrated in a flow chart. In a first step 23 a player requests camera and phone access which the user can allow or deny. If denied, the process stops. If allowed, a live picture appears in a preview screen. In a second step 24, the user can select from online master resumes and sample video scripts and text templates from a server 15. Each video part is given a title by the user, and the text that is later spoken and recorded can be created in writing. Text for the scripts can be changed or deleted, and entire video parts can be deleted. Notes for the script will be displayed in a separate teleprompter window when recording the video. Speed of the teleprompter can be adjusted by the user.

In a third step 25, the user uploads cover letters, resumes, and other documents in different formats such as rtf, doc, PDF or html. A built-in PDF converter converts all files and file types to PDF format if desired by the user. Users can upload the user's files (resume, cover letter, credentials, etc.) in different formats such as Word, HTML, or PDF. Pdf is the most practicable format for the viewer (recruiter). Therefore the system has implemented an automatic PDF converter for the users who upload files other than PDF format. This saves the user the time and hassle or learning how to convert files.

In a fourth step 26, the user starts recording by selecting the record button and the teleprompter starts automatically if desired. When the recording is completed, the user can replay the recording to review it going back and forth between parts and repeating recording if necessary. Users that don't have a web cam can still use the system by just recording voice or audio while a static picture is displayed in the video window instead of the user's picture.

In a fifth step 27, the user determines the background color, font, color, etc of the application page and a selection of the layout, font style, and font size of the application is also made. Next a preview of the entire online application including all video parts, cover letter, and attachments such as reference letters, transcripts, etc are included. A user then chooses a password to protect access to job application page and the password created by the user will be required by anyone to view the video resume.

In a sixth and final step 28, the user configures his personal FTP server space or uploads the entire video application onto the system's server 15. Once published the user registers and chooses a name for the user's URL. For example a user may select http://first.lastname.gocvone.com. The user then categorizes and tags the resume by entering personal registration data and categories that specify the job position wanted. Or the user transfers the video resume to the user's own FTP space. Once saved on the server, the video resume can be viewed and the user can send the link to recruiters and companies or post it on online job boards, social networking websites, etc.

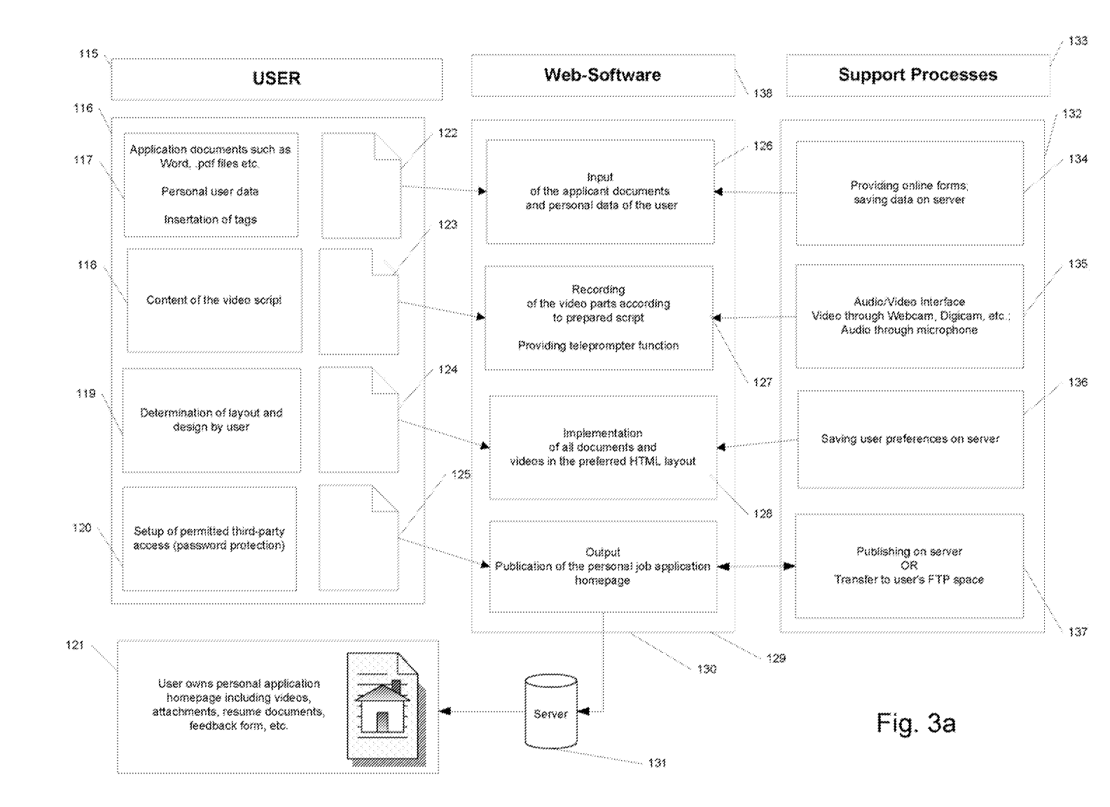

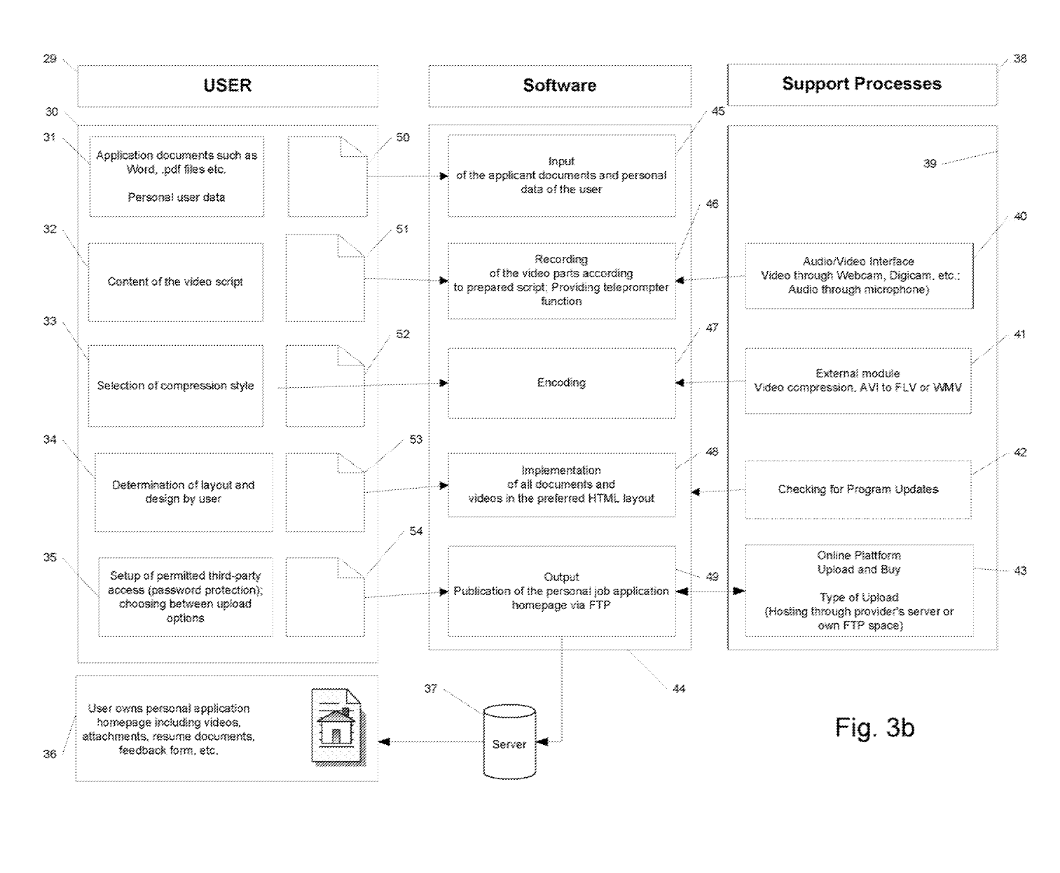

Referring to FIG. 3a, the recruiting process from creation of the application by a job seeker to viewing of the application by a recruiter using web-software 138 is illustrated. The user 115 accesses the system software web browser 130 located on a web server 131, from a computer 116 connected to the same network. Input of the user's documents and personal data of the user 126 and documents such as Word, PDF files 122 with personal user data 117 are stored on the system's web server 131. Content of the video script 118 is stored as files 123 and the software enables the recording of the video parts 127. A user also determines the layout 119 which is embodied in a file 124 that is implemented 128 by the system software. A user also sets up permission of third party access by choosing between upload options 120 which creates files 125 that the system generates as output or publications via FTP 129 for the server 131 which also provides the user a personal application homepage including videos, attachments, resume documents, and a feedback form 121.

Support processes 133 are provided through an audiovisual interface 132 for recording videos using web cams, digi cams, and microphones 135 or other video and audio recording devices. A first module provides means for providing online forms and saving data 134 on the server 131. Another module provides means for saving user preferences 136 on the server 131. The support processes 133 also provides an online platform for publishing on the server 131 or transferring to a user's FTP space 137.

Now referring to FIG. 3b the recruiting process from creation of the application by a job seeker to viewing of the application by a recruiter using downloadable system software is illustrated. The user 29 retains in the system software, located on a server 37, documents such as Word, PDF files 50 with personal user data 31 that is stored in the system software 45. Content of the video script 32 is stored as files 51 and the software enables the recording of the video parts 46. A user's may select from a plurality of compression styles 33 to create files 52 that are encoded 47 by the system software. A user also determines the layout 34 which is embodied in a file 53 that is implemented 48 by the system software. A user also sets up permission of third party access by choosing between upload options 35 which creates files 54 that the system generates as output or publications via FTP 49 for the server 37 which also provides the user a personal application homepage including videos, attachments, resume documents, and a feedback form 36.

Support processes 38 are provided through an audiovisual interface for recording videos using web cams, digi cams, and microphones 40 or other video and audio recording devices. An external module 41 provides video compression while another module provides means for program updates 42. The support process 38 also provides an online platform for upload and purchase 43.

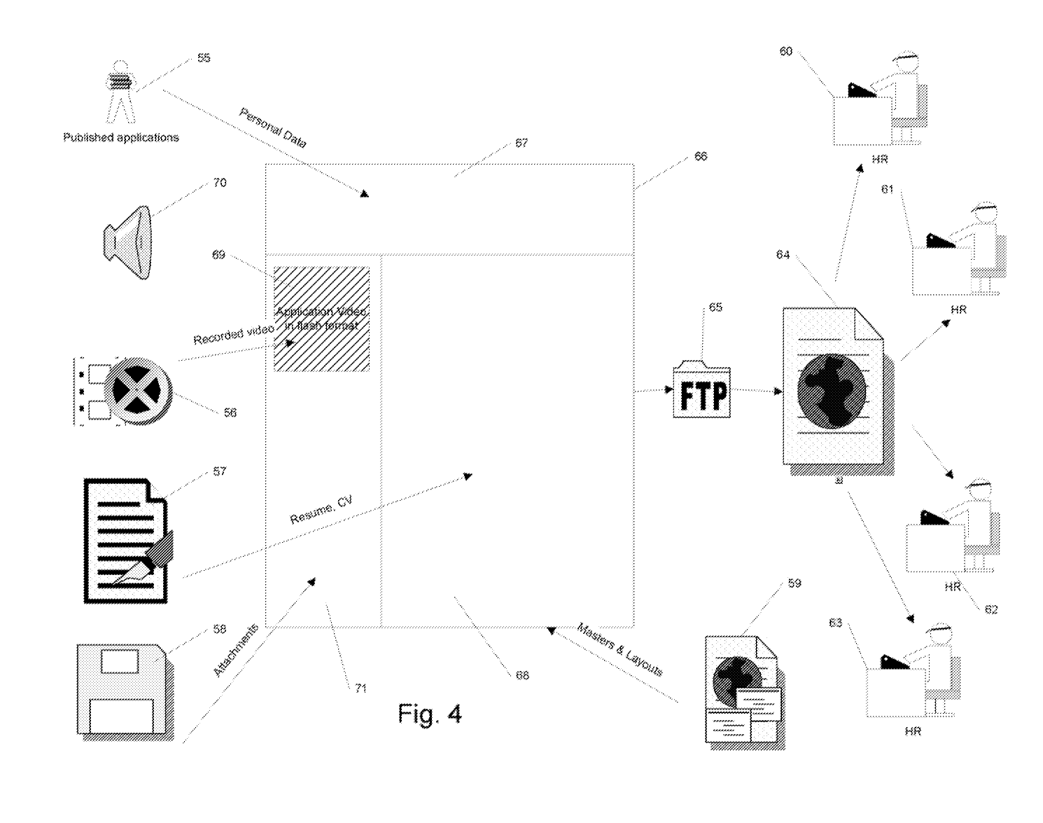

Referring to FIG. 4, the present invention is software for job seekers to create and publish an application home page 66. The home page 66 consists of two parts—a video segment 71 for viewing the recorded videos 56, audio recordings 70, and documents viewing segment 68 for viewing supporting documents uploaded by a user such as; resume 57, transcripts and reference letters 58. A user uploads published applications 55 recorded videos 56, audio recordings 70, or supporting documents such as resume 57, transcripts and reference letters 58 to the system's web servers. Each user gets a personalized URL 67, and the page will be securely hosted on the system's web servers. Thus, no technical knowledge, HTML skills, or video-processing software is necessary.

The system's web servers provides means for storing the resumes 57 and support documents 57 and contains the masters and templates 59 for use by a user on the system in creating a home page 66. The server also provides means for a user to FTP 65 the user's video resume to a web space 64 that can be searched by one or more human resource directors or employee seekers 60-63.

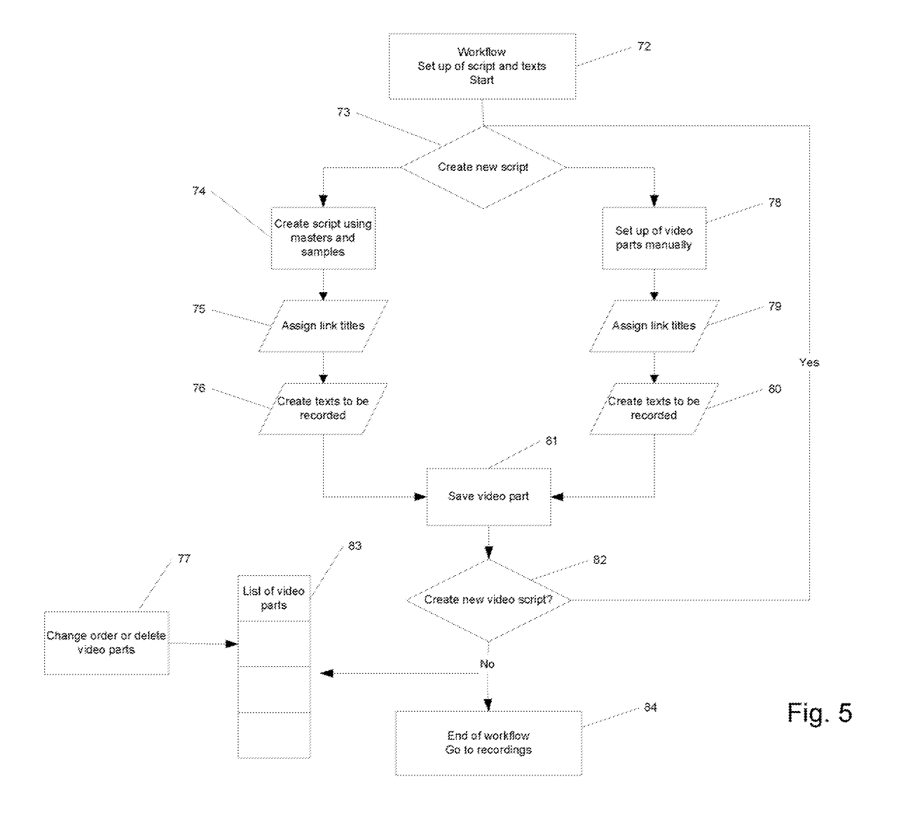

FIG. 5 is a flow chart of the preparation of the video script including texts and titles 72 for both an embodiment enabled via a web browser and downloadable software. If a user decides to create a new script 73 one of two parallel paths of actions must be followed. The user must either create a script using masters and samples 74 or set up the video parts manually 78. If the user created the script using materials and samples 74, link titles are assigned automatically 75 but can be edited and the text to be recorded 76 is provided from the samples and can also be edited and is saved after altered to a users satisfaction. If a user manually sets up the video parts 78, the user must manually assign link titles 79 and create the text to be recorded 80. Upon completion of the manual set up, the video part is saved 81. After creating a first video part, the user has the option to create additional video parts 81 and repeat the process, end the process 84 and create a list of video parts 83 which can be changed, re-ordered, or deleted 77.

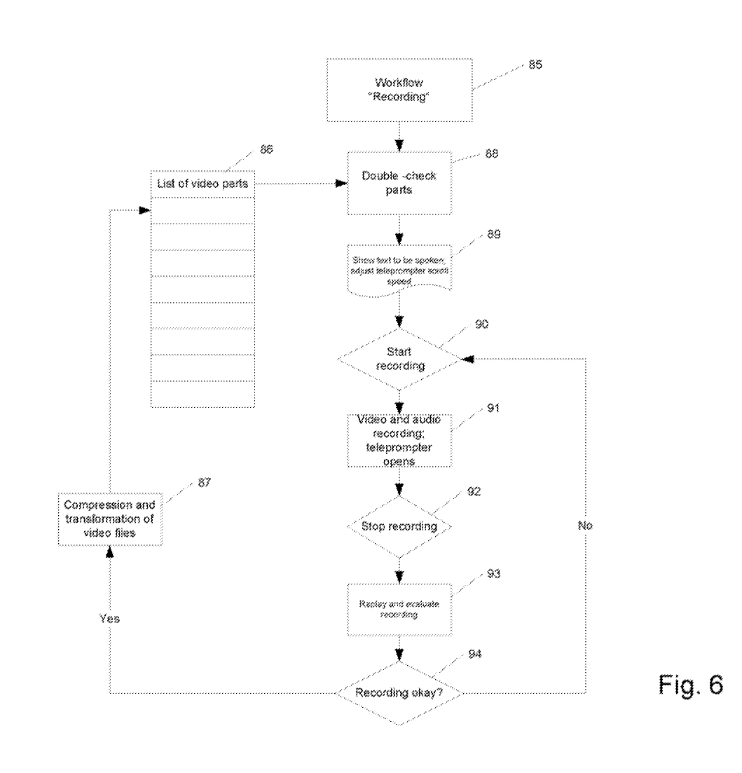

FIG. 6 is a flow chart of the video recording process for both an embodiment enabled via a web browser and downloadable software. The workflow for recording 85 of video parts 88 starts with a user creating a list of video parts 86 to be recorded. Video parts 88 are comprised of list of sections 86. The text to be spoken 89 is then shown and the recording starts 90. A teleprompter appears and the video and audio recording starts 91 and then stops 92 at completion by a user. A user can then replay 93 the recording for evaluation. If the recording is okay 94 the recording is compressed and transformed into a video file 87 and the system moves on to the next video part on the list 86 to be recorded. If the recording is not okay 94, the user can return and start the recording process 90 again for that video part.

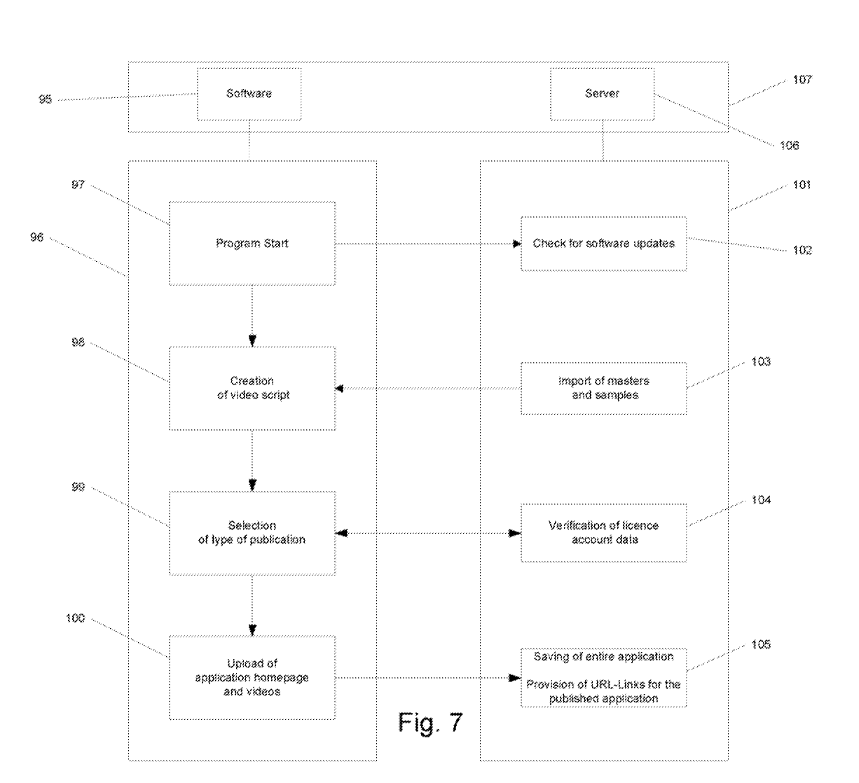

FIG. 7 demonstrates the interaction between downloadable software and the server. The software 95 is downloaded by a user to the user's personal computer 96. When a user starts 97 the system software 95, the software checks the server 106 for software updates 102. When the user starts the software program from his PC or laptop, the system has an integrated automatic check for program updates meaning, new releases which we have done between the users previous and current use.

During the creation of a video script by a user, masters, questions, and samples 103 are downloaded from the server 106 to the user's personal computer 96. When a user selects a publication type 99, verification of a license and account data 104 is done by the server 106. When the user uploads an application homepage and videos, the sever 106 saves and stores the entire application and also provides publication means for URL links 105.

Instead of downloading the system software and create the user's video application on the user's own PC or laptop and upload it to the server in the end, users in the alternative web version embodiment can work directly on the system server to create the user's video application.

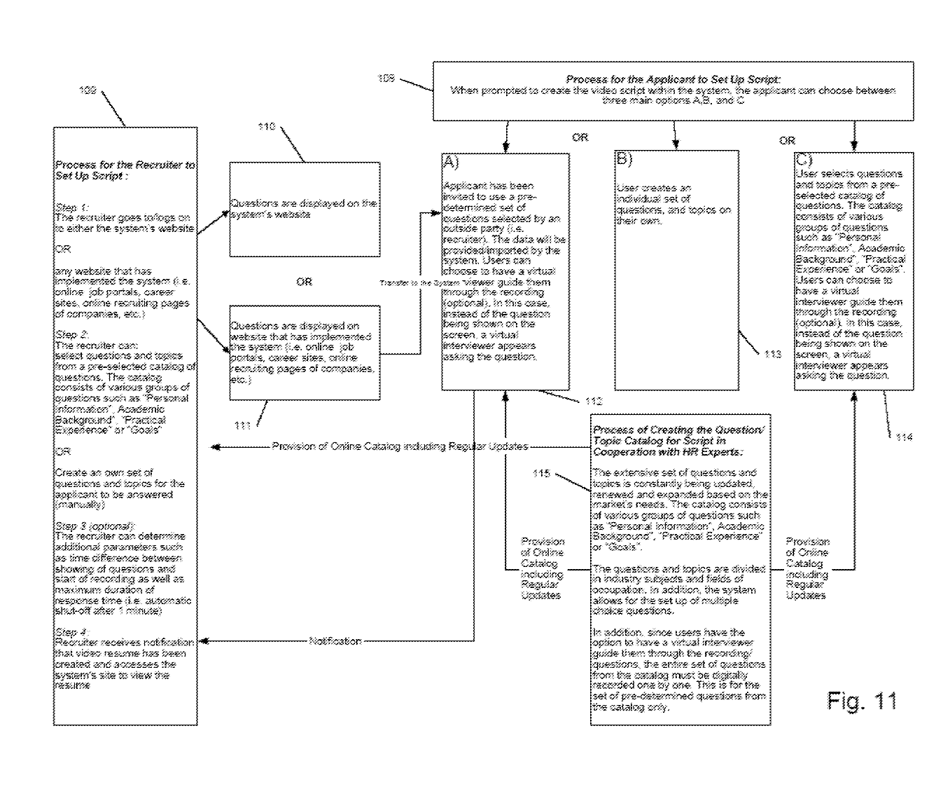

Now referring to FIG. 11, a flow chart illustrating the process for script creation from a question catalog is shown. The process for the user/user to set up a script starts 108 when the user is prompted to create the video script within the system, the user then chooses between three main options.

In a first option the user has been invited to use a pre-determined set of questions selected by an outside party 112 such as a recruiter. The data will be provided/imported by the system. Users can choose to have a virtual interviewer guide them through the recording. If the virtual interviewer guide is chosen, instead of the question being shown on the screen, a virtual interviewer appears asking the question.

In a second option a user creates an individual set of questions, and topics 113.

In a third option a user selects questions and topics from a pre-selected catalog of questions 114. The catalog consists of various groups of questions such as “Personal Information”, Academic Background”, “Practical Experience” or “Goals”. Users can choose to have a virtual interviewer guide them through the recording. Again, if the virtual interviewer guide is chosen, instead of the question being shown on the screen, a virtual interviewer appears asking the question.

One a user selects a script creation option, the process of creating a question/topic catalog for a script in cooperation 115 occurs. An extensive set of questions and topics is constantly being updated, renewed and expanded based on the market's needs. The catalog consists of various groups of questions such as “Personal Information”, Academic Background”, “Practical Experience” or “Goals”. The questions and topics are divided in industry subjects and fields of occupation. In addition, the system allows for the set up of multiple choice questions.

In addition, since users have the option to have a virtual interviewer guide them through the recording/questions, the entire set of questions from the catalog must be digitally recorded one by one, but only for the set of pre-determined questions from the catalog only.

Still referring to FIG. 11, the process for the recruiter to set up script is illustrated 109. In a first step, the recruiter goes to/logs on to either the system's website 110 or any website that has implemented the system such as an online job portal, career site, or online recruiting pages of companies 111. In a second step, the recruiter can select questions and topics from a pre-selected catalog of questions or create a customized set of questions and topics for the user to be answered manually. The recruiter's catalog also consists of various groups of questions such as “Personal Information”, Academic Background”, “Practical Experience” or “Goals”

If desired, a recruiter can determine additional parameters such as time difference between showing of questions and start of recording as well as maximum duration of response time such as an automatic shut-off after one minute.

In a final step, the recruiter receives notification when a video resume has been created and accesses the system's site to view the resume.

In yet another alternative embodiment of the present invention, a filler-word counter may be incorporated into the review process. Many job applicants user filler words when recording video resume such as “umm”, “ah”, “like”, and “you know”. After recording the video, a separate window opens that allows the applicant to count the number of filler words when re-viewing the recorded video part. The applicant is then prompted to press respective keyboard buttons that correspond to target filler words whenever a filler word has been used.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and the user's legal equivalents, rather than by the examples given.

1. A method for creating a video application for distribution over a computer network, comprising:
a. downloading system software from a server to create a video application on a PC or laptop;
b. automatically checking for program updates from a PC or laptop to the server;
c. converting a traditional job application process into a video application process;
d. uploading and presenting all three parts of a video application on one page;
e. selecting of different layouts for the video application;
f. uploading and storing of a resume file to a server;
g. scripting of video parts and creation of video parts with headlines, descriptions, and text;
h. a recording countdown;
i. viewing via replay and preview functions;
j. selection of video application layout to customize the video application;
k. uploading the video application to the system's server;
l. publishing and creation of URL links; and
m. transmitting the URL links to employers, recruiters, career centers, friends, etc.

2. The method for creating a video application for distribution over a computer network of claim 1 wherein the parts of the video application include; a video, a resume, a cover letter, and other attachments.

3. The method for creating a video application for distribution over a computer network of claim 2, further comprising:
splitting the video application in to different parts or sections and recording and storing them separately; and
naming and assigning sections of the video application.

4. The method for creating a video application for distribution over a computer network of claim 2, further comprising:
recording notes that will later appear when recording the video;
accessing templates for a video script; and
downloading and selecting various scripts, texts, and suggestions for section titles.

5. The method for creating a video application for distribution over a computer network of claim 1, further comprising:
accessing a server directly to create a video application with a non-downloadable version of the system software;
displaying a teleprompter when recording a video, the speed of said teleprompter being adjustable;
uploading files in one or more formats; and
automatically converting uploaded files in one ore more formats to a single desired format type.

6. The method for creating a video application for distribution over a computer network of claim 1, further comprising:
providing for the posting of a video application page on a the system's server or a private server.

7. The method for creating a video application for distribution over a computer network of claim 7 wherein the video application is comprised of a static picture and audio recording.

8. The method for creating a video application for distribution over a computer network of claim 7 wherein recording starts through mouse click followed by a countdown and the recorded video parts can be replayed, deleted, and recorded again until a satisfactory result has been achieved.

9. The method for creating a video application for distribution over a computer network of claim 1 wherein when uploading the video application to the system's server;
the video is transformed and compressed into a specified electronic format and the transformation and compression process is visible via a progress report; and
upon successful transformation and compression, a preview function enables viewing of the entire portfolio.

10. The method for creating a video application for distribution over a computer network of claim 1 further comprising:
providing digital layouts stored on the server;
selecting one of the layouts and designs for the video application and all the other related digital documents including design, color, font style, and font size.

11. A system for creating a video application for distribution over a computer network, comprising:
A. means for downloading software for creating a video application;
B. means for accessing a web page;
C. means for setting up a video script for a video application;
D. means for determining a number of video parts and content of each respective video part;
E. means for recording of the video and audio parts of a video application according to the script;
F. means for transforming the recording into a desired electronic format;
G. mean for previewing the recording; and
H. means for determination of the design of the video application along with sorting attachments and video parts, selecting color, font and layout.

12. The system for creating a video application for distribution over a computer network of claim 11, comprising:
A. means for requesting camera and phone access which provide a live picture to appear in a computer preview screen;
B. means for select from online master resumes and sample video scripts and text templates from a server;
C. means for giving each video part a title;
D. means for recording the spoken text in audio or written format;
E. means for editing text and an entire video parts;
F. mean for displaying notes for a script in a separate teleprompter window when recording a video;
G. means for adjusting the speed of the teleprompter;
H. means for recording a video and starting the teleprompter automatically if desired;
I. means for reviewing the recording to review it going back and forth between parts and repeating recording if necessary;
J. means for providing an overview and status report of all video parts completed;
K. means for transforming and compressing the video into a desired electronic format and displaying a status report of the compressing;
L. means for determining the background color, font, color of the application page and a selection of the layout, font style, and font size of the application;
M. means for providing a preview of the entire online application;
N. means for choosing a password to protect access to the video application page; and
O. means for configuring personal FTP server space or uploading the entire video application onto the system's server.

13. A system for creating a video application for distribution over a computer network, comprising:
A. means for accesses a web page and server;
B. means for setting up a video script for a video application with respect to number and content of video parts;
C. means for uploading of job application documents to a server;
D. means for recording of video and audio parts according to the script;
E. means for determining the design of the application along with sorting attachments and video parts, selecting color, font and layout and previewing; and
F. publication of the video application via the server to the Internet.

14. The system for creating a video application for distribution over a computer network of claim 13, comprising:
A. means for requesting camera and phone access to create a live picture in a preview screen of the web page;
B. means for selecting from online master resumes and sample video scripts and text templates from a server;
C. means for giving each video part a title;
D. means for creating text to be later spoken and recorded or created in writing, said text for the scripts can be changed or deleted an entire video parts can be deleted;
E. means for displaying notes for the script in a separate teleprompter window of the web page when recording the video, the speed of the teleprompter can be adjusted;
F. means for uploading cover letters, resumes, and other documents in different electronic formats to the server;
G. means for converting all files and file types to a single file type desired;
H. means for starting a recording and the teleprompter;
I. means for replaying the recording to review it and back and forth between parts and repeating recording;
J. means for tracking filler words in the recording;
K. means for determination of the background color, font, and color of the application page and a selection of the layout, font style, and font size of the application;
L. means for providing a preview of the entire online application including all video parts, cover letter, and attachments in the web page;
M. means for choosing a password to protect access to job application page and control access; and
N. means for configuring a personal FTP server space or uploading the entire video application onto the system's server.

15. The system for creating a video application for distribution over a computer network of claim 14, comprising:
means for publishing the video application and choosing a URL name for the user's URL after uploading the entire video application onto the system's server;
means for categorizing and tagging of the video application;
means for entering personal registration data and choosing categories that specify the job position wanted; and
means for reviewing the video application on the server and sending links to recruiters and companies or postings on online job boards, and social networking websites.

16. The system for creating a video application for distribution over a computer network of claim 13, comprising:
means for script creation by a user drawing questions from a question catalog;
means for script creation enabling a user to create an individual set of questions and topics; and
means for script creating enabling a user to selects question and topics from a pre-selected catalog of questions.

17. The system for creating a video application for distribution over a computer network of claim 16, comprising means for script creation from a question catalog by a user wherein the user has been invited to use a pre-determined set of questions selected by an another party.

18. The system for creating a video application for distribution over a computer network of claim 16, comprising means for
providing a virtual interviewer to guide the user through the recording; and
tracking and counting the use of filler words during a review of the recording.

19. The method for creating a video application for distribution over a computer network of claim 1, further comprising:
creation of a script by a user drawing questions from a question catalog;
creation of a script by a user from an individual set of questions and topics; and
creation of a script by a user selecting question and topics from a pre-selected catalog of questions;
guiding a user through the recording using a virtual interviewer;

20. The method for creating a video application for distribution over a computer network of claim 19, further comprising:
accessing the system's website or any website that has implemented the system by a recruiter;
selecting questions and topics from a pre-selected catalog of questions or create a customized set of questions and topics by a recruiter for a user to be answered manually.
setting additional recording limitations; and
notifying a recruiter when a video resume has been created and a recruiter accessing the server to view the resume.
